(19) United States
(12) Patent Application Publication
(10) Pub. No.: US 2004/0149955 A1
(43) Pub. Date: Aug. 5, 2004

(54) Non-combustible polyesterpolyol and/or polyetherpolyol preblend for producing foamed products

(75) Inventors: Lothar Zipfel, Laatzen (DE); Karsten Borner, Sehnde (DE); Dierk-Ingolf Recke, Wunstorf (DE)

Correspondence Address: CROWELL & MORING LLP, INTELLECTUAL PROPERTY GROUP, P.O. BOX 14300, WASHINGTON, DC, 20044-4300, US

(73) Assignee: Solvay Fluor und Derivate GmbH, Hannover (DE)

(21) Appl. No.: 10/712,257

(22) Filed: Nov. 14, 2003

Related U.S. Application Data
(63) Continuation of application No. PCT/EP02/04185, filed on Apr. 16, 2002.

(30) Foreign Application Priority Data
May 16, 2001 (DE) 101 23 604.2

(51) Int. Cl. C09K 3/00

(52) U.S. Cl. 252/182.24

(57) ABSTRACT

A non-combustible polyether polyol and/or polyester polyol premix for the production of foamed products, in particular PU foams, composed of a polyol, more than 4% by weight of a binary blowing-agent mixture containing HFC 365mfc and a further fluorohydrocarbon, and 10 to 20% by weight of a phosphorus-based flameproofing agent.

### CROSS REFERENCE TO RELATED APPLICATIONS

This application is a continuation of international patent application no. PCT/EP02/04185, filed Apr. 16, 2002, designating the United States of America, and published in German as WO 02/092676, the entire disclosure of which is incorporated herein by reference. Priority is claimed based on Federal Republic of Germany patent application no. DE 101 23 604.2, filed May 16, 2001.

### BACKGROUND OF THE INVENTION

The present invention relates to non-combustible polyester polyol and/or polyether polyol premixes for the production of foams, in particular of polyurethane foam products.

Polyurethane foams are produced by reaction of isocyanates with a polyol or a polyol mixture in the presence of blowing agents, preferably hydrofluoroalkanes.

The use of 1,1,1,3,3-pentafluorobutane (HFC365mfc) as a blowing agent for the production of polyurethane foams is known. Since 1,1,1,3,3-pentafluorobutane has a flashpoint of below −27° C., it is regarded as a readily flammable liquid and limits are set on its use as a blowing agent. Usually, therefore, 1,1,1,3,3-pentafluorobutane is used in a mixture with other fluorohydrocarbons.

Known blowing-agent mixtures contain in addition to HFC365mfc e.g. 1,1,1,2-tetrafluoroethane (HFC-134a) or 1,1,1,2,3,3,3-heptafluoropropane (HFC 227ea) or 1,1,1,3,3-pentafluoropropane (HFC 245fa). These blowing-agent mixtures have no flashpoint and are suitable for the production of foamed plastics.

It is likewise known and conventional, in order to produce foams, first to produce what are called premixes from the different feed materials, and afterward to react the premix with the isocyanate. For the preparation of the premix, polyols or polyethers, blowing agents, catalysts and optionally further additives are mixed together in the required amounts. The foams are then produced by bringing the premix into contact with the isocyanate or isocyanates.

If premixes are prepared using the aforementioned blowing-agent mixtures, when a critical quantity of blowing agent is exceeded surprisingly it may happen that the entire system has to be classified as combustible owing to the low flashpoint, although the blowing-agent mixture and polyol system per se are not combustible.

### SUMMARY OF THE INVENTION

The object of the invention is to provide a non-combustible, stable premix for the production of foams which does not have a flashpoint, even with a blowing-agent content of more than 4% by weight in the system.

Premixes according to the invention are composed of:

a) Polyol. Preferably a polyether polyol and/or a polyester polyol is used.

b) 4 to 35% by weight, preferably 10 to 15% by weight, blowing-agent mixture. In addition to HFC365mfc, the blowing-agent mixture contains at least 5% by weight, preferably 7% by weight, of a further fluorohydrocarbon, preferably HFC134a, HFC227ea or HFC245fa; and

c) 10 to 20% by weight, preferably 10 to 15% by weight, of a phosphorus compound, preferably triethyl phosphate or tris-chloroisopropyl phosphate.

Known phosphorus-based flameproofing agents may likewise be used as the phosphorus compound.

Further additions, such as catalyst, stabilizer and further additives can be admixed to the premix in known manner.

### DESCRIPTION OF THE EMBODIMENTS

The premix according to the invention is contacted with isocyanate or isocyanates and foamed in a known manner.

Usually polyisocyanates, for example with 2 to 4 isocyanate groups, are used for the production of the polyurethane foams. Their preparation and the basic chemicals usable therefor are well known in the art.

These isocyanates have an aliphatic hydrocarbon radical with up to 18 C atoms, a cycloaliphatic hydrocarbon radical with up to 15 C atoms, an aromatic hydrocarbon radical with 6 to 15 C atoms or an araliphatic hydrocarbon radical with 8 to 15 C atoms. Starting materials which are particularly preferred industrially include, for example, 2,4- and 2,6-toluylene diisocyanate, diphenylmethane diisocyanate, polymethylene polyphenyl isocyanate and mixtures thereof. Also what are called modified polyisocyanates, which contain carbodiimide groups, urethane groups, allophanate groups, isocyanurate groups, urea groups or biuret groups, may be used.

Further starting materials are compounds with at least two hydrogen atoms which are reactive with respect to isocyanates. These are in particular compounds with a molecular weight of 400 to 10,000, which preferably contain 2 to 8 hydroxyl groups and furthermore may contain amino groups, thiol groups or carboxyl groups.

Additionally chemical blowing agents such as water can be added as further auxiliaries and additives to the system which is to be foamed. Catalysts such as, for example, tertiary amines, such as dimethylcyclohexylamine, and/or organic metal compounds also can be used. Surface-active additives, such as emulsifiers or foam stabilizers, for example siloxane polyether copolymers, reaction-delaying agents, cell regulators such as paraffins, fatty alcohols or dimethylpolysiloxanes, pigments and dyes, may be used. Furthermore, stabilizers against the effects of ageing and the weather, fillers, dyes, antistatic agents, nucleating agents, pore-regulating substances or biocidal active substances may be used.

Suitable catalysts are mentioned, for example, in U.S. Pat. No. 6,303,667 (=WO 96/14354), the disclosure of which is incorporated herein by reference. These include organic amines, aminoalcohols and aminoethers such as morpholine compounds, for example dimethylcyclohexylamine, diethanolamine, 2-dimethylaminoethyl-3-dimethylaminopropylether, 2-dimethylaminoethylether, 2,2-dimorpholinodiethylether, N,N-dimethylaminoethylmorpholine and N-dimethylmorpholine. Also organometallic compounds such as for example tin, cobalt or iron compounds can be used as catalyst. Examples which can be used are tin dioctoate, cobalt naphthenate, dibutyltin dilaurate and iron acetonylacetate.

An advantage of the premix according to the invention is that the solubility characteristics of the constituents are modified due to the addition of flameproofing agents such as triethyl phosphate, tris-chloroisopropyl phosphate and further phosphates or phosphonates, so that the flashpoint rises and the classification “combustible” no longer applies. Thus simple storage and transport of the premix is possible.

### EXAMPLE 1

Polyether polyol (Tercarol A350) was mixed with 10% by weight blowing agent (relative to polyol) and the flashpoint was determined. A binary mixture of 94% HFC 365mfc and 6% by weight HFC 227ea was used as blowing agent.

Flashpoint according to DIN EN ISO 13736: 15° C.

### EXAMPLES 2 TO 5

A premix was prepared analogously to Example 1 from polyether polyol (Tercarol A350) and 10% by weight binary blowing-agent mixture and also additionally triethyl phosphate (TEP) or tris-chloroisopropyl phosphate (TCPP) were added. The flashpoint was determined in accordance with DIN EN ISO 13763. No flashpoint could be determined.

TABLE 1

| Examples | Blowing-agent mixture | Ratio | Phosphorus compound |
|---|---|---|---|
| 2 | HFC 365 mfc/HFC 227 ea | 94:6 | 10% by weight TEP |
| 3 | HFC 365 mfc/HFC 227 ea | 94:6 | 13% by weight TCCP |
| 4 | HFC 365 mfc/HFC 134 ea | 93:7 | 15% by weight TEP |
| 5 | HFC 365 mfc/HFC 245 ea | 75:25 | 10% by weight TEP |

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A non-combustible premix for production of foamed products, said premix comprising at least one polyol selected from the group consisting of polyether polyols and polyester polyols; from 4 to 35% by weight of a binary blowing-agent mixture, and 10 to 20% by weight of a phosphorus compound; wherein said binary blowing agent comprises a mixture of:
a) 1,1,1,3,3-pentafluorobutane, and
b) 1,1,1,2-tetrafluoroethane, 1,1,1,2,3,3,3-heptafluoropropane or 1,1,1,3,3-pentafluoropropane.

2. A non-combustible premix according to claim 1, wherein the premix further comprises a catalyst, a stabilizer, or an additional blowing agent.

3. A non-combustible premix according to claim 1, wherein the premix further comprises at least one additive selected from the group consisting of reaction-delaying agents, cell regulators, fatty alcohols, dimethylpolysiloxanes, pigments, dyes, fillers, antistatic agents, nucleating agents, pore-regulating substances and biocidal active substances.

4. A non-combustible premix according to claim 1, wherein the premix comprises 10 to 15% by weight of the binary blowing-agent mixture.

5. A non-combustible premix according to claim 1, wherein said phosphorus compound is triethyl phosphate or tris-chloroisopropyl phosphate.

6. A non-combustible premix according to claim 1, wherein the premix contains 10 to 15% by weight of said phosphorus compound.
